(19) United States
(12) Patent Application Publication
(10) Pub. No.: US 2016/0308836 A1
(43) Pub. Date: Oct. 20, 2016

(54) VIRTUAL PRIVATE NETWORK SECURITY APPARATUS AND OPERATION METHOD THEREOF

(71) Applicant: ELECTRONICS AND TELECOMMUNICATIONS RESEARCH INSTITUTE, Daejeon (KR)

(72) Inventors: Pyung Koo PARK, Daejeon (KR); Ho Sun YOON, Daejeon (KR); Ho Yong RYU, Daejeon (KR); Sung Back HONG, Daejeon (KR)

(21) Appl. No.: 15/017,833

(22) Filed: Feb. 8, 2016

(30) Foreign Application Priority Data
Apr. 15, 2015 (KR) 10-2015-0053235

(51) Int. Cl. H04L 29/06

(52) U.S. Cl. CPC H04L 63/0272; H04L 63/08; H04L 63/029

(57) ABSTRACT

An operation method of a VPN security apparatus includes receiving a service request from a client, dynamically allocating a fake address of a VPN apparatus connected to a service server, which provides the service requested by the client, and transmitting the fake address allocated to the VPN apparatus to the client and the VPN apparatus.

### CROSS-REFERENCE TO RELATED APPLICATION

The present application claims priority to Korean patent application numbers 10-2015-0053235 filed on Apr. 15, 2015, the entire disclosure of which is incorporated herein in its entirety by reference.

### BACKGROUND

1. Field of Invention

Various embodiments of the present disclosure relate to a virtual private network (VPN) security apparatus and an operation method thereof.

2. Description of Related Art

Due to its open properties, an IP network is attackable with only an IP address. In order to prevent such vulnerability, Internet Protocol security (IPsec) is used. However, typical IPsec may secure data but expose an IP header for packet forwarding. Accordingly, when a destination address in the IP header is exposed, it is possible for an attacker to increase loads to an IPsec support device by means of a flooding attack, etc.

FIG. 1 is a conceptual diagram for a typical IPsec virtual private network (VPN) service.

Generally an IPsec VPN is used for security communication in service servers 161, 162, . . . , and 16N located inside a data center or an enterprise network 140 by using a public network 120 such as the Internet. At this point, a VPN apparatus 150 is present at a boundary of the data center or the enterprise network 140 and a terminal and a client 111, 112, . . . , or 11k, which desire to access, request and set IPsec VPN tunnels 131, 132, . . . , and 13k. The IPsec VPN is divided into a tunnel mode and a transport mode, and a description herein will be provided on the basis of the tunnel mode.

FIG. 2 illustrates a data configuration for a typical IPsec VPN service.

When a security tunnel is set between a client 110 and a VPN device 150 through a network 120, data necessary for security is transmitted through the security tunnel. At this point, the data 210 is encoded and transmission data is generated by using the IP header 220. In addition, a header 230 of the generated IPsec VPN (hereinafter referred to security tunnel) is added ahead of the data 210. At this point, since the Internet network is used in the middle, the security tunnel header necessarily uses an IP address that general network equipment may know. The VPN device 150 receiving the data decodes the data by using the security tunnel header and restores original data 240 and IP header 250.

When a third party accessing the Internet network becomes to know the security tunnel header, in terms of open properties of the IP internet network, since a continuous IPsec VPN setting request may be transferred to the IPsec VPN device, performance of the IPsec VPN device may be lowered and finally an unserviceable case may occur. In this case, the disabled state of the IPsec VPN device may cause an entirely unserviceable state.

### SUMMARY

Various embodiments of the present disclosure are directed to providing a VPN security apparatus for allocating a virtual address for each user and service and an operation method thereof.

One embodiment of the present disclosure provides an operation method of a VPN security apparatus. The operation method includes: receiving a service request from a client; dynamically allocating a fake address of a VPN apparatus connected to a service server, which provides the service requested by the client; and transmitting the fake address allocated to the VPN apparatus to the client and the VPN apparatus.

Another embodiment of the present disclosure provides an operation method of a VPN apparatus. The operation method includes: receiving a packet through a fake address allocated from a VPN security apparatus; performing network address translation (NAT) for translating the fake address in a header of the received packet into an original address; and decoding the packet on which the NAT is performed to remove an address for the VPN apparatus from the header of the packet.

Still another embodiment of the present disclosure provides a VPN security apparatus includes: a communication unit transmitting and receiving data with a client and a VPN device; an address allocation unit dynamically allocating a fake address of a VPN apparatus connected to a service server that provides the service requested by the client; and a control unit controlling to transmit the fake address, which is allocated to the VPN apparatus by the address allocation unit, to the client and the VPN apparatus, when the service request is received from the client.

Further another embodiment of the present disclosure provides a VPN apparatus includes: a communication unit transmitting and receiving data with a client and a VPN security apparatus; and a control unit controlling to receive a packet through a fake address allocated by the VPN security apparatus, perform NAT for translating the fake address in a header of the received packet into an original address, and to decode the NAT-performed packet to remove an address for the VPN apparatus from the header of the packet.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a conceptual diagram for a typical IPsec virtual private network (VPN) service;

FIG. 2 illustrates a data configuration for a typical IPsec VPN service;

FIG. 3 is a conceptual diagram illustrating a VPN security system according to an embodiment of the present disclosure;

FIG. 4 is a flowchart illustrating an operation method of a VPN security apparatus according to an embodiment of the present disclosure;

FIG. 5 illustrates a data configuration in a VPN security system according to an embodiment of the present disclosure;

FIG. 6 is a block diagram illustrating an internal configuration of a VPN apparatus according to an embodiment of the present disclosure;

FIG. 7 illustrates a data processing procedure of a VPN apparatus according to an embodiment of the present disclosure;

FIG. 8 is a flowchart illustrating an operation method of a VPN security apparatus according to an embodiment of the present disclosure; and

FIG. 9 illustrates a mechanism for delivering a virtual address according to an embodiment of the present disclosure.

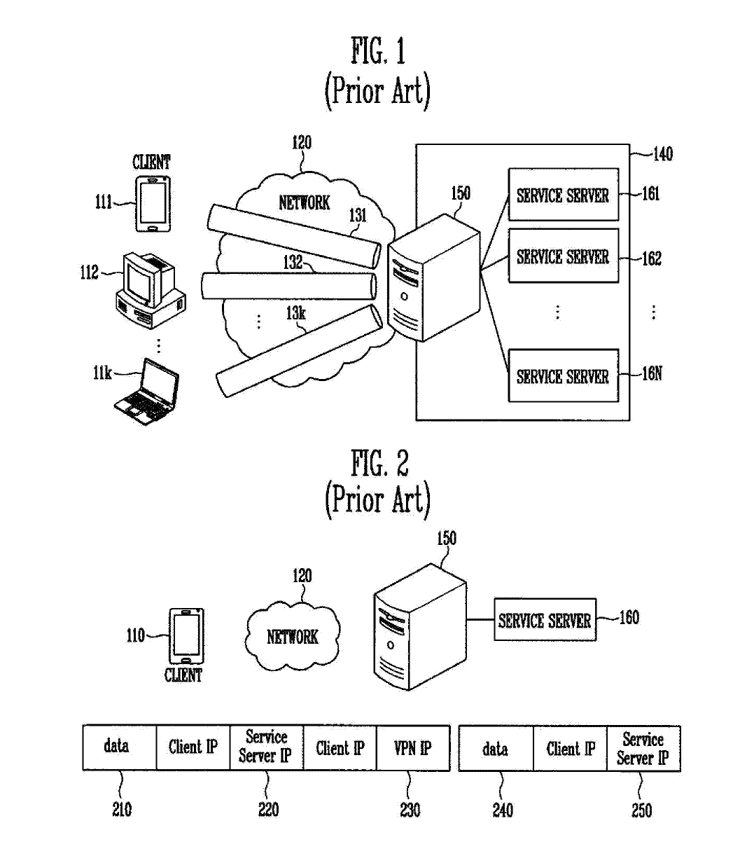

### DETAILED DESCRIPTION

Hereinafter, it will be described in detail about an exemplary embodiment of the present invention in conjunction with the accompanying drawings. It should be noted that like reference numerals refer to like constituent elements in the drawings. In addition, detailed descriptions of well-known functions or constructions will be omitted since they would obscure the disclosure in unnecessary detail

In addition, if certain parts are described as being “connected” to other parts, they are not only “directly connected” to the other parts, but also “indirectly connected” to the other parts with any other device intervened therebetween. In addition, when an element is referred to as “comprising” or “including” a component, it does not preclude another component but may further include the other component unless the context clearly indicates otherwise.

FIG. 3 is a conceptual diagram illustrating a virtual private network (VPN) security system according to an embodiment of the present invention.

Referring FIG. 3, a VPN security system according to an embodiment of the present disclosure includes a client 110, a VPN security apparatus 310, and a VPN apparatus 150. Herein the VPN apparatus 150 may be an Internet Protocol security (IPsec) VPN apparatus.

The client 110 and the VPN apparatus 150 are configured with basic apparatuses for service and the VPN security apparatus 310 performs controls on the client 110 and the VPN apparatus 150.

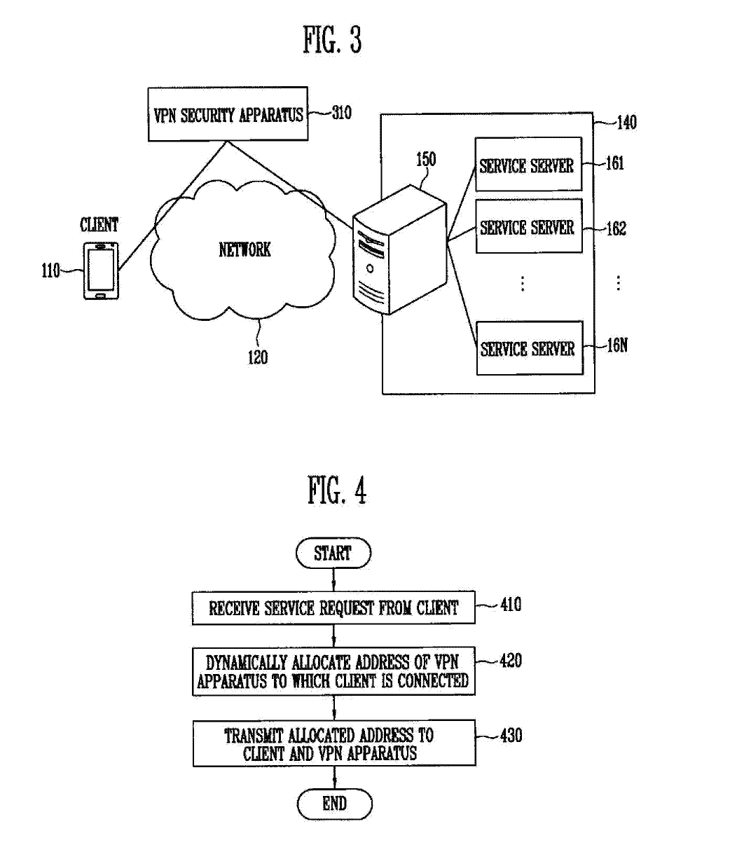

The VPN security apparatus 310 dynamically allocates address information on the VPN apparatus 150 to which the client 110 is connected. The VPN security apparatus 310 may interlock with an authentication system and dynamically allocate an address after the authentication. Such an operation procedure of the VPN security apparatus is illustrated in FIG. 4.

FIG. 4 is a flowchart illustrating an operation method of a VPN security apparatus according to an embodiment of the present disclosure.

Referring to FIG. 4, first, in operation 410, the VPN security apparatus 310 receives a service request from the client 110. According to an embodiment of the present disclosure, after receiving the service request from the client 110, the VPN security apparatus 310 may authenticate the client 110.

Then, in operation 420, the VPN security apparatus 310 dynamically allocates a fake address of the VPN apparatus 150, which is connected to a service server providing the service requested by the client. Here, the fake address means a virtual address which is not an original address of the VPN apparatus 150. According to an embodiment of the present disclosure, one address is arbitrarily selected from an address pool of the VPN apparatus 150 and the selected address may be allocated as the fake address. In addition, the VPN security apparatus 310 may also allocate a fake address of the service server.

Next, in operation 430, the VPN security apparatus 310 transmits the fake address allocated to the VPN apparatus 150 to the client 110 and the VPN apparatus 150.

Furthermore, periodically or when a set event occurs, the VPN security apparatus 310 may allocate a new fake address to the VPN apparatus 150 and transmit the new fake address to the client 110 and the VPN apparatus 150.

In order to dynamically allocate address information on the VPN apparatus 150 to which the client 110 is connected, the VPN security apparatus 310 may include a communication unit, an address allocation unit, and a control unit. The communication unit may transmit and receive data with the client 110 and the VPN security apparatus, the address allocation unit may dynamically allocate the fake address of the VPN apparatus 150, which is connected to a service server for providing a service requested by the client 110, and the control unit may control an overall operation process of the VPN security apparatus 310, namely, a process for transmitting the fake address, which is allocated to the VPN apparatus 150 by the address allocation unit, to the client 110 and the VPN apparatus 150 when the service request is received from the client 110.

FIG. 5 illustrates a data configuration in a VPN security system according to an embodiment of the present disclosure.

Referring to FIG. 5, a Fake VPN IP address 530 and a Fake Service Server IP address 520, which are allocated by the VPN security apparatus 310, are added ahead of data 510. When such a packet is transmitted from the client 110 to the VPN apparatus 150 through a network 120, the VPN apparatus 150 removes the Fake VPN IP address 530 through decoding. In addition, the Fake Service IP address 520 is changed to an original address 550 to be transmitted to the service server 160. Through such a process, the service server 160 determines that the client 110 requests a service with the original address.

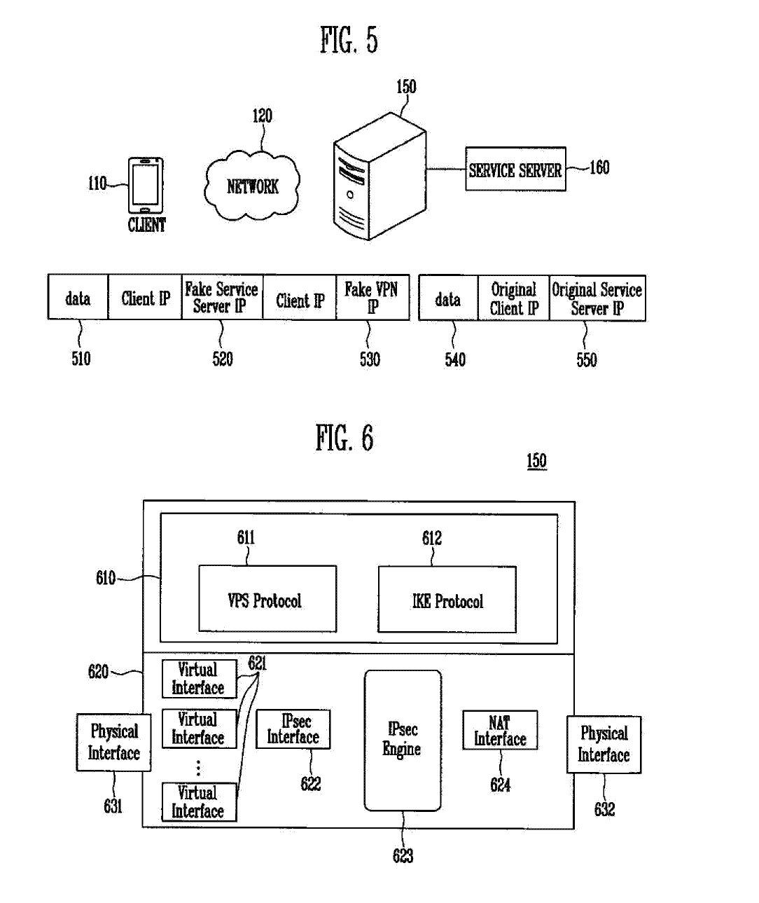

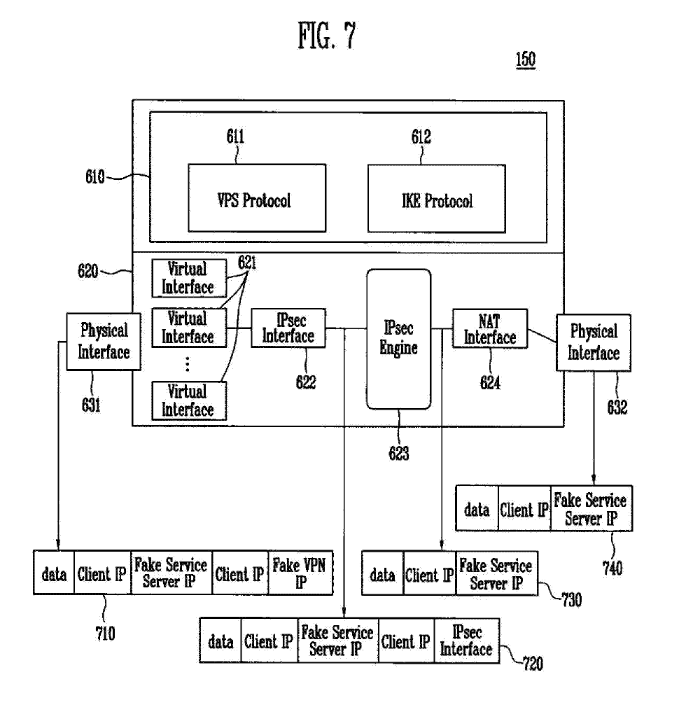

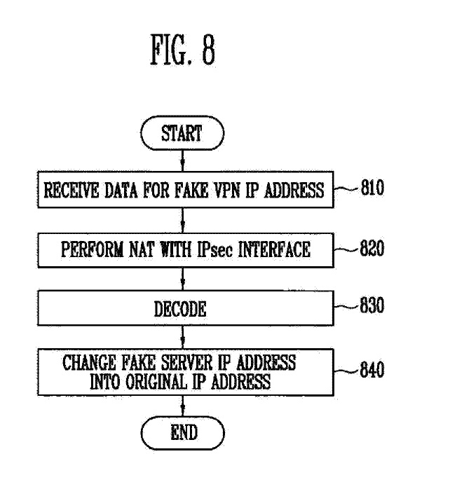

FIG. 6 is a block diagram illustrating an internal configuration of a VPN apparatus according to an embodiment of the present disclosure and FIG. 7 illustrates a data processing procedure of a VPN apparatus according to an embodiment of the present disclosure.

As explained in relation to FIG. 5, in order that the service server 160 provides the service, the Fake Service Server IP address is required to be changed to the original address. In addition, the Fake IP address for the VPN apparatus 150 is required to be changed to an address used in an original internet key exchange (IKE) protocol 612. At this point, the VPN apparatus 150 may be represented on a control plane 610 and a data plane 620.

The control plane 610 is configured with a VPN security apparatus (VPS) interlocking protocol 611 and the IKE protocol 612, and the data plane 620 may include a virtual interface 621, an IPsec interface 622, an IPsec engine 623, and a network address translation (NAT) interface 624. In addition, the data plane 620 is connected to physical interfaces 631 and 632.

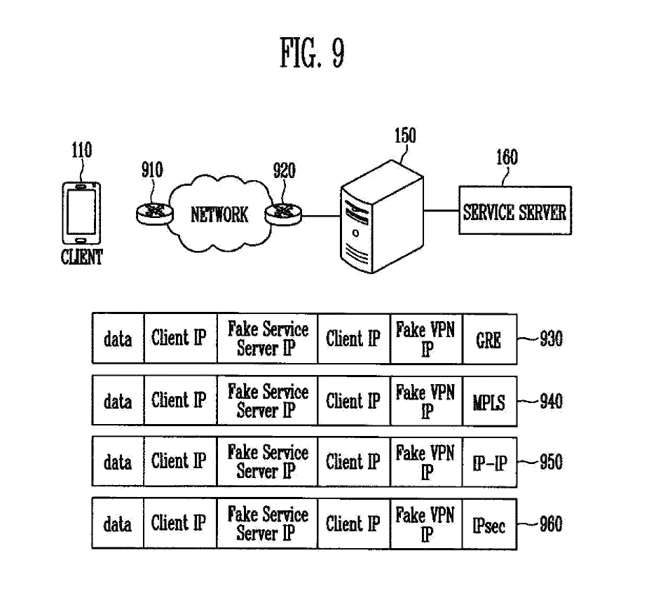

At this point, the IKE protocol 612 is driven for one IPsec interface 622, and each virtual address may be generated from a virtual interface 621. Data 710, which is input through the physical interface 631, is input to a corresponding virtual interface. The IPsec interface 622 performs NAT on the data 710 to make data 720 for which the Fake VPN IP address is removed. Such data 720 is input to the IPsec engine 623 and is decoded (operation 730). The NAT interface 624 changes the Fake Service Server IP address in the decoded data 730 into the original IP address and outputs the original IP address to the service server through the physical interface 632. Such an operation process of the VPN apparatus is illustrated in FIG. 8.

FIG. 8 is a flowchart illustrating an operation method of a VPN security apparatus according to an embodiment of the present disclosure.

Referring to FIG. 8, first, in operation 810, the VPN apparatus 150 receives a packet through a fake address allocated by the VPN security apparatus 310. According to an embodiment of the present disclosure, the packet may be received through a tunnel formed by using the fake address between the client 110 and the VPN apparatus 150.

Then in operation 820, the VPN apparatus 150 performs the NAT for translating, into the original address, the fake address for the VPN apparatus 150 in a header of the received packet.

Then in operation 830, the packet on which the NAT is performed is decoded and an address for the VPN apparatus 150 is removed from a header of the packet.

Furthermore, the VPN apparatus 150 may translate the fake address for the service server in the received packet into the original address and transmit the packet to the service server.

The VPN apparatus 150 may include a communication unit and a control unit for performing such a process. The communication unit may transmit and receive data with the client and the VPN security apparatus, and the control unit may control the entire operation process of the VPN apparatus 150, namely, a process for receiving a packet through a fake address allocated by the VPN security apparatus 310, performing NAT for translating the fake address in the header of the received packet into the original address, and for decoding the packet, on which the NAT is performed, to remove the address for the VPN apparatus from the header of the packet.

According to the present disclosure, an attack is not possible even if an attacker comes to know the address of the VPN apparatus 150 by using a virtual IPsec VPN address. In particular, when the virtual address is not routable, network equipment in the middle of the network drops attack traffics.

FIG. 9 illustrates a mechanism for delivering a virtual address according to an embodiment of the present disclosure.

Referring to FIG. 9, when an arbitrary address is allocated to a virtual address, the IRE protocol does not allow a packet to be delivered. Accordingly, the network devices 910 and 920 may deliver packets to the IPsec VPN apparatus 150 by using tunnels defined by standard. At this point, as an available tunnel structure, GRE 930, MPLS 940, IP-IP 950, and IPsec 960, etc., may be adopted.

According to various embodiments of the present disclosure, an address of a VPN apparatus may be dynamically changed to secure the VPN apparatus.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An operation method of a VPN security apparatus, the method comprising:
receiving a service request from a client;
dynamically allocating a fake address of a VPN apparatus connected to a service server providing the service requested by the client; and
transmitting the fake address allocated to the VPN apparatus to the client and the VPN apparatus.

2. The method of claim 1,
wherein the dynamically allocating of the fake address comprises:
selecting one address from an address pool; and
allocating the selected address to the fake address.

3. The method of claim 1, after the transmitting of the fake address, further comprising:
allocating a new fake address to the VPN apparatus when a set event occurs; and
transmitting the new fake address allocated to the VPN apparatus to the client and the VPN apparatus.

4. The method of claim 1,
wherein the dynamically allocating of the fake address comprises dynamically allocating a fake address of the service server.

5. The method of claim 1, after the receiving the service request, further comprising:
authenticating the client.

6. An operation method of a VPN apparatus, the method comprising:
receiving a packet through a fake address allocated from a VPN security apparatus;
performing network address translation (NAT) for translating the fake address in a header of the received packet into an original address; and
decoding the packet on which the NAT is performed to remove an address for the VPN apparatus from the header of the packet.

7. The method of claim 6, after the decoding of the packet, further comprising:
translating the fake address for the service server in the received packet into an original address; and
transmitting the received packet to the service server.

8. The method of claim 6,
wherein the receiving of the packet through the fake address comprises receiving the packet through a tunnel formed by using the fake address between the client and the VPN apparatus.

9. A VPN security apparatus comprising:
a communication unit configured to transmit and receive data with a client and a VPN device;
an address allocation unit configured to dynamically allocate a fake address of a VPN apparatus connected to a service server that provides the service requested by the client; and
a control unit configured to control to transmit the fake address allocated to the VPN apparatus by the address allocation unit, to the client and the VPN apparatus, when the service request is received from the client.

10. The VPN security apparatus of claim 9,
wherein the address allocation unit arbitrarily selects one address from an address pool and allocates the selected address to the fate address.

11. The VPN security apparatus of claim 9,
wherein the address allocation unit allocates a new fake address to the VPN apparatus when a set event occurs.

12. The VPN security apparatus of claim 9,
wherein the address allocation unit dynamically allocates a fake address of the service server.

13. The VPN security apparatus of claim 9,
further comprising an authenticating unit configured to authenticate the client.

14. A VPN apparatus comprising:
a communication unit configured to transmit and receive data with a client and a VPN security apparatus; and
a control unit configured to control to receive a packet through a fake address allocated by the VPN security apparatus, to perform NAT for translating the fake address in a header of the received packet into an original address, and to decode the NAT-performed packet to remove an address for the VPN apparatus from the header of the packet.

15. The VPN apparatus of claim 14,
wherein the control unit further controls to translate a fake address for a service server into an original address in the received packet and to transmit the packet to the service server.

16. The VPN apparatus of claim 14,
wherein the control unit receives the packet through a tunnel formed by using the fake address between the client and the VPN apparatus.
